(19) United States
(12) Patent Application Publication
(10) Pub. No.: US 2009/0071328 A1
(43) Pub. Date: Mar. 19, 2009

(54) GRID TYPE ELECTROSTATIC SEPARATOR/COLLECTOR AND METHOD OF USING SAME

(76) Inventor: John P. Dunn, Horseheads, NY (US)

Correspondence Address: BROWN & MICHAELS, PC;400 M & T BANK BUILDING, 118 NORTH TIOGA ST, ITHACA, NY, 14850, US

(21) Appl. No.: 12/248,942

(22) Filed: Oct. 10, 2008

Related U.S. Application Data
(63) Continuation-in-part of application No. 11/380,714, filed on Apr. 28, 2006.
Application No. 11/380,714 is a continuation-in-part of application No. 10/872,981, filed on Jun. 21, 2004, now Pat. No. 7,105,041.
Application No. 10/872,981 is a continuation-in-part of application No. 10/225,523, filed on Aug. 21, 2002, now Pat. No. 6,773,489.
(60) Provisional application No. 60/979,206, filed on Oct. 11, 2007.
(60) Provisional application No. 61/086,274, filed on Aug. 5, 2008.
(60) Provisional application No. 60/675,575, filed on Apr. 28, 2005.
(60) Provisional application No. 60/722,026, filed on Sep. 29, 2005.
(60) Provisional application No. 60/716,425, filed on Sep. 13, 2005.

(51) Int. Cl. B03C 3/38; B03C 3/00

(52) U.S. Cl. 95/62; 95/57; 95/79; 95/78; 96/54; 96/16

(57) ABSTRACT

In one embodiment, apparatuses and methods for collecting particulates use an aperture air flow control system and an inline series of alternating discharge and grid type electrodes each with a separate electrical circuit centrally located between either parallel grid electrodes or plate electrodes. In another embodiment, an external enclosed pre-discharger design and physical arrangement improves agglomeration of sub-micron particles. In yet another embodiment, an external opposing dual channel discharger design also improves agglomeration of particles. In another embodiment, two or more separate electrode arrangements are used within a collecting chamber to improve the operation and collection efficiency of the apparatus. The present invention also preferably increases the frequency of recharging the particles, to increase collection efficiency. In one embodiment, the collection chamber includes both a recharging zone and a high voltage zone followed by a series of fields separated by agglomerating recharging units.

### REFERENCE TO RELATED APPLICATIONS

This application claims one or more inventions which were disclosed in Provisional Application No. 60/979,206, filed Oct. 11, 2007, entitled “GRID TYPE ELECTROSTATIC SEPARATOR/COLLECTOR AND METHOD OF USING SAME” and Provisional Application No. 61/086,274, filed Aug. 5, 2008, entitled “GRID TYPE ELECTROSTATIC SEPARATOR/COLLECTOR AND METHOD OF USING SAME”. The benefit under 35 USC § 119(e) of the United States provisional applications is hereby claimed, and the aforementioned applications are hereby incorporated herein by reference.

This is also a continuation-in-part of co-pending patent application Ser. No. 11/380,714, filed Apr. 28, 2006, which is a continuation-in-part of patent application entitled “GRID TYPE ELECTROSTATIC SEPARATOR/COLLECTOR AND METHOD OF USING SAME”, Ser. No. 10/872,981, filed Jun. 21, 2004, now U.S. Pat. No. 7,105,041, which is a continuation-in-part of patent application entitled “GRID TYPE ELECTROSTATIC SEPARATOR/COLLECTOR AND METHOD OF USING SAME”, Ser. No. 10/225,523, filed Aug. 21, 2002, now U.S. Pat. No. 6,773,489, and claims one or more inventions which were disclosed in Provisional Application No. 60/675,575, filed Apr. 28, 2005, entitled “CORONA PARTICLE CHARGER”, Provisional Application No. 60/722,026, filed Sep. 29, 2005, entitled “CORONA PARTICLE CHARGER”, and Provisional Application No. 60/716,425, filed Sep. 13, 2005, entitled “GRID ELECTROSTATIC PRECIPITATOR/FILTER FOR DIESEL ENGINE EXHAUST REMOVAL”. The aforementioned applications are hereby incorporated herein by reference.

### BACKGROUND OF THE INVENTION

1. Field of the Invention

The invention pertains to the field of separator apparatuses. More particularly, the invention pertains to an apparatus that can function as a filter unit as a precipitator or as a separator of materials that have different electrical properties.

2. Description of Related Art

U.S. Pat. No. 4,172,028 discloses an electrostatic sieve having parallel sieve electrodes that are either vertical or inclined. The particles are normally introduced into the electric sieve under the control of a feeder that is placed directly in front of the opposing screen electrode. The powder is attracted directly from the feeder tray to the opposing screen electrode by induced electric field that exists between the tray and the screen electrode. This system is a static air system.

Prior art precipitators have difficulty collecting highly conductive and very poorly conductive particulates.

### SUMMARY OF THE INVENTION

The present invention includes an improved apparatus for collecting particulates using an aperture air flow control system and an inline series of alternating discharge and grid type electrodes each with a separate electrical circuit centrally located between either parallel grid electrodes and/or plate electrodes.

The present invention also includes a method for improving the rate of lateral movement and collection of particulates using the aperture air flow control system and an inline series of alternating discharge and grid type electrodes each with a separate electrical circuit centrally located between either parallel grid electrodes and/or plate electrodes.

In a preferred embodiment, the spacing between parallel grid and discharge electrodes varies between 0.50 and 1.50 inches with a narrow air stream being drawn between the electrodes.

The present invention also includes an improved method of charging particles using a pre-charger designed with a narrow air input channel. Using a narrow air input channel into the main air stream increases the probability that entrained particles and generated ions will come in contact, resulting in a high percentage of particles being charged.

In another embodiment, an external enclosed pre-discharger design and physical arrangement improves agglomeration of sub-micron particles. The present invention also includes an external opposing dual channel discharger design to improve agglomeration of particles. In one embodiment, two or more separate electrode arrangements are used within the collecting chamber to improve the operation and collection efficiency of the apparatus. In another embodiment, multiple collection chambers are placed in series, preferably with a discharge chamber placed in between each of the collection chambers to recharge the particles. Various designs recharge the particles, to increase collection efficiency.

### BRIEF DESCRIPTION OF THE DRAWINGS

FIG. 1 shows a cross sectional view of a cylindrical or rectangular multiple grid separator/collector of U.S. Pat. No. 7,105,041, herein incorporated by reference.

FIG. 2 shows a cross sectional view of a cylindrical or rectangular grid separator/collector of U.S. Pat. No. 7,105,041 that has a center corona wire, multiple grids, and plate electrodes.

FIG. 3 shows a cross sectional view of a rectangular multiple grid separator/collector of U.S. Pat. No. 7,105,041 that has a normally grounded center grid electrode located between two opposing charged electrodes.

FIG. 4 shows a cross sectional view of a modified-U-shaped electrode grid separator/collector apparatus of U.S. Pat. No. 7,105,041.

FIG. 5 shows an enlarged cross-sectional view of the radius of the U shaped electrode grid separator/collector and the interaction of the various forces affecting separation.

FIG. 6 shows a cross-sectional view of a grid separator/collector of the present invention, with alternating discharge and grid type electrodes each with a separate electrical circuit centrally located between parallel grid or plate electrodes.

FIG. 7 shows a section drawing of an example of a grid used in the electrostatic precipitator/collector of the present invention.

FIG. 8 shows a cross sectional view of a dual channel discharger in an embodiment of the present invention.

FIG. 9 shows a cross sectional view of opposing external enclosed discharge chambers in an embodiment of the present invention.

FIG. 10 shows a cross sectional view of an electrode configuration for collection of sub-micron particles in an embodiment of the present invention.

FIG. 11 shows a pre-discharger and collection chamber arrangement in an embodiment of the present invention.

FIG. 12 shows a cross-sectional view of a corona generating electrode design that uses a 45 degree angle chamber on each side of the main entrained airflow passage.

FIG. 13 shows a cross-sectional view of two saw tooth corona electrodes located in a corona chamber with each electrode facing an attracting electrode, where gases pass through the electrical field into a control orifice and into the main entrained air stream.

FIG. 14 is a cross-sectional view showing two opposing corona-charging electrodes, one wire electrode, and another saw tooth electrode that are located in an aperture where gases to be charged flow around the corona charging electrodes.

### DETAILED DESCRIPTION OF THE INVENTION

A grid electrostatic precipitator (GEP) is a dynamic air system where a gradient air flow exists between the center air flow and collecting plate electrodes. External discharge electrodes are designed to charge and then agglomerate the fine particles into larger particles for ease of collection.

The present invention includes a grid type electrostatic precipitator/collector with a narrow air stream, various external pre-discharger designs with the ability to agglomerate sub-micron particles into larger particles and one or more collection chambers (fields). The pre-chargers preferably include a narrow air input channel. In one embodiment, the collection chamber includes both a recharging zone and a high voltage zone. In another embodiment, at least two collection chambers are placed in series and are separated by agglomerating recharging units. In yet another embodiment, one or more of the collection chambers placed in series includes a recharging zone and a high voltage zone. The present invention also addresses the differential flow pattern, illustrated in FIG. 10 and discussed in U.S. Pat. No. 6,482,253, herein incorporated by reference, that occurs between the central flow and the airflow at the surface that faces the discharge electrode and the back side surface of the grid electrodes, where a substantial drop in flow occurs and the collecting plate electrodes.

In the embodiments of the present invention, the main air stream is preferably a single column of air flowing in a vertical direction or a single row of air flowing in a horizontal direction.

One problem with agglomeration is that, once two or more particles agglomerate into a larger, agglomerated particle, the agglomerated particle loses polarity. The present invention solves this problem by recharging these particles, permitting them to agglomerate further, which makes them even easier to collect. Recharging may be repeated over and over, to further increase the collection efficiency of the apparatus.

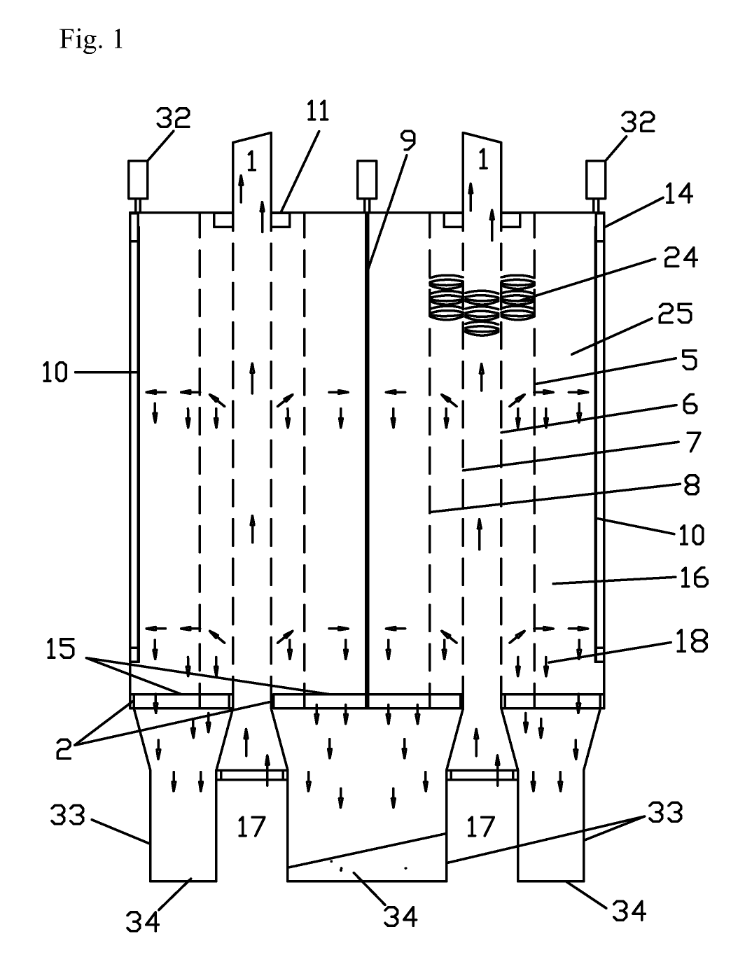

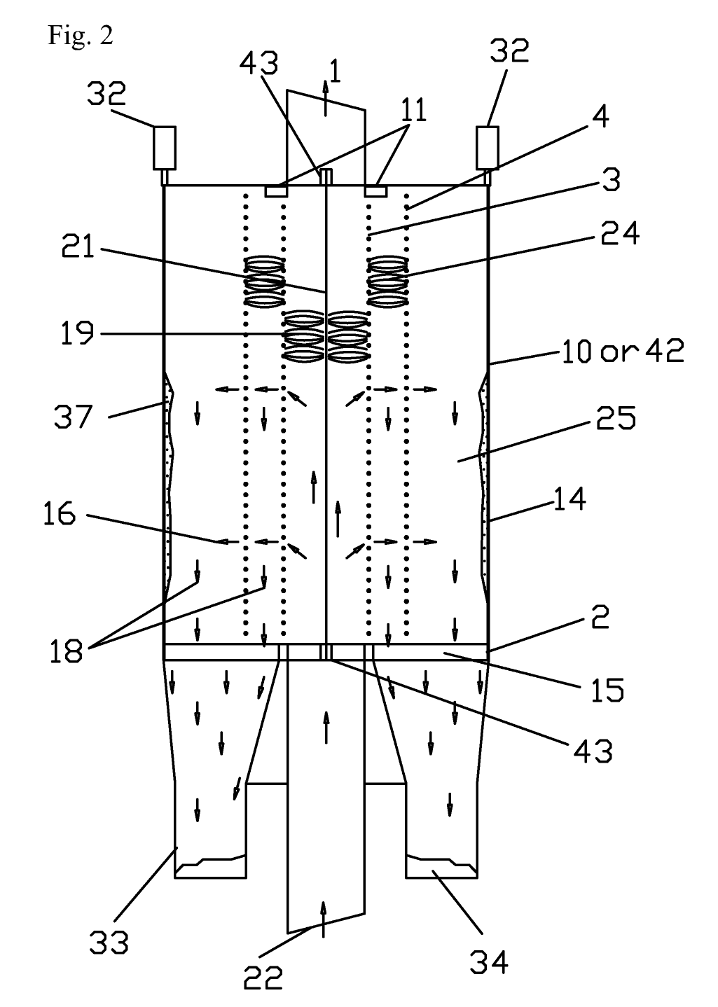

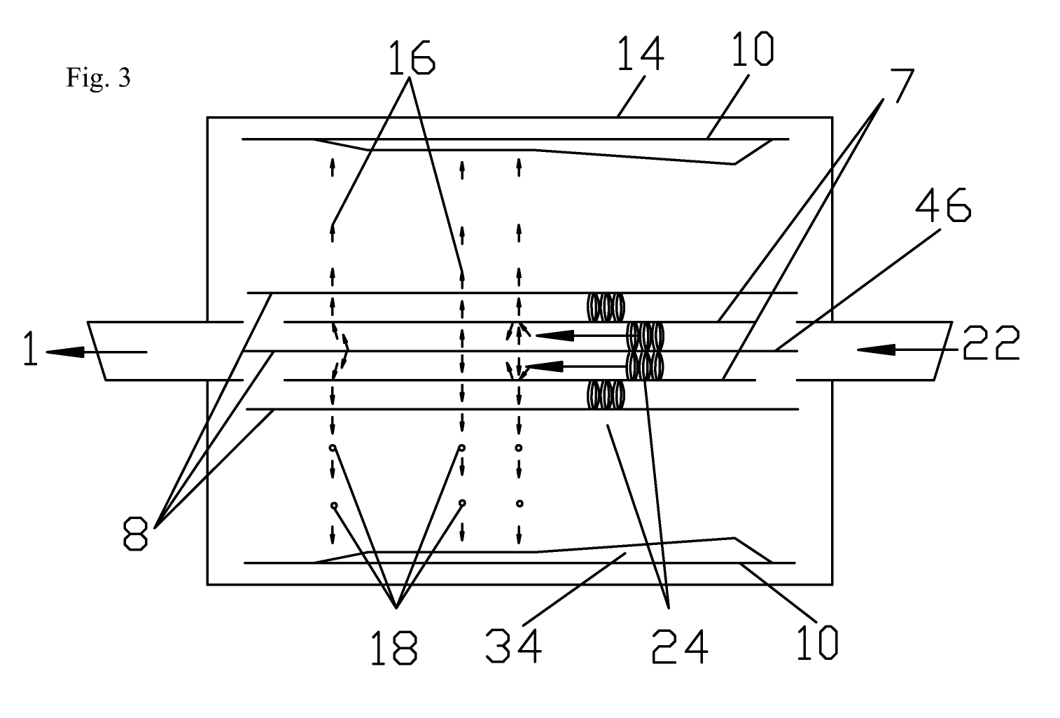

FIG. 1 illustrates a cross-section of a vertical, rectangular, dual vertical grid type electrostatic separator/collector (GES/C). The apparatus includes a structural frame (14) and a center support plate electrode (9) with entrained gas entering at (17) and exiting at (1). It is important to have a narrow column (or row) of airflow and good control of the internal pressure. The air stream is preferably drawn into the apparatus. The entrained gas flows between a polarized charging grid (7) and the ground potential grid electrode (6). Directly behind the two input grids (6) and (7) are additional grid electrodes (8), at ground potential, and a charged grid (5). It should be understood that the apparatus could be expanded laterally so that other grid electrodes can be used to move the particles further from the air stream. The apparatus is also a sealed unit so that the air stream is restricted between the input (17) and (22) (see FIGS. 2-3) and the gas exit conduits (1). This unit can be designed to operate with the input air moving either vertically or horizontally through the apparatus.

An electric field (24) is established between the alternating electrodes (5) and (6), (6) and (7), and (7) and (8). Generally the spacing between the last grid electrodes (7) and (8), and the plate electrode results in the absence of an electric field because of the distance between the plate and the grid electrodes. The charged particles move laterally (16), and gravitationally settle (18) in the open space (25).

When processing large, high-density particles, these particles may gravitate out of the process before the next grid electrode or the collection plate electrode (10). The collecting plate electrode (10) is used when collecting fine non-conductive particles or when there is a mixture of conducting and non-conducting particles. Deposited particles are removed by a tapping apparatus (32), or by a squeegee or other removal methods. The spacing between parallel grid electrodes preferably varies between ⅜ and 1.50 inches.

The spacing between electrodes, the electrical potential between electrodes and the number of grid electrodes are each a function of the concentration of solids in the air stream, the size of the particles, electrical and physical characteristics of the particles, and flow rate, as well as other process variables.

The grid supports (2) and (11) are preferably constructed from a dielectric material with openings (15) in the collection area. The dislodged powder falls by gravity or is tapped from the plate electrodes (10) and is collected (34) at the bottom of the precipitating chamber (33).

FIG. 2 illustrates another vertical GES/C. A wire electrode (21) or other type of corona-generating electrode can be used to generate the necessary ions. The corona wire (21) is supported at both ends (43). This arrangement is preferred primarily for processing non-conductive particulates. For processing conductive particles, the corona wire is removed and the grid electrodes are moved closer together. This Figure also uses a single input (22) in contrast with the dual input (17) shown in FIG. 1. The electric field lines of force (19) are generated at 90 degrees to the flow of the entrained gas input and illustrate the area where gas ions are produced by the corona discharge electrode (21). The charged particles that follow these lines of force result in the separation of the solid particles by passing through the grounded electrode (3) and the charged electrode (4) from the air stream (22) and are collected by gravity (18) or, for some materials, deposited (37) on the plate electrode (10). When designed as a rectangular unit, it can be operated with the input air moving either vertically or horizontally through the apparatus. When designed as a circular apparatus the grids are in a circular pattern and the solid plate electrode (42) is a cylinder.

FIG. 3 shows a top view of another separator/collector. This separator is designed to operate with a high solid to gas ratio or when a high number of particle clusters are found in the material. Entrained air can enter either in a vertical mode or a horizontally mode as shown by (22) and flows between the grounded electrodes (7) and the charging plate or grid electrode (46), dividing the stream into basically two processing zones. The concentration or spacing between wire grids of each electrode is preferably varied to provide more or fewer lines of force that determine the number of trails a particle may have before moving laterally onto the next electrode grid. When the concentration of the solid is high, the center electrode (46) is the charging electrode and the electrodes (7) are at ground potential. These units preferably operate in a vertical position with either horizontal or perpendicular air input.

The polarities of the electrodes change when the apparatus processes clusters of powder that are lightly bonded and need more resident time to break down into smaller particles that respond to the electrical forces available.

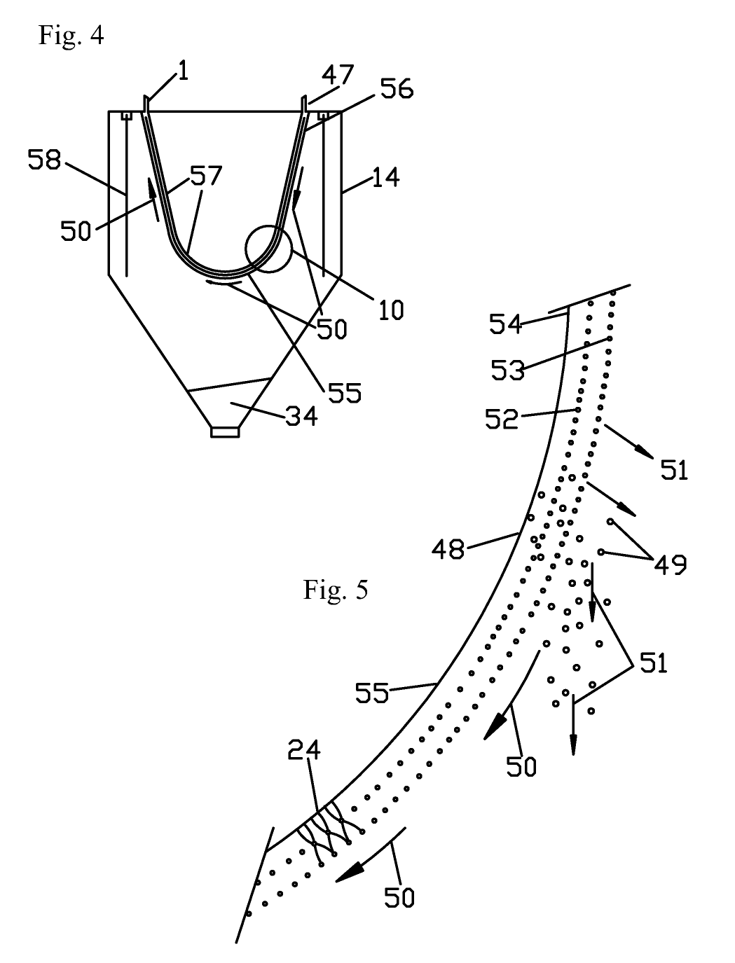

FIGS. 4 and 5 show another design used to separate fine particles from an entrained air stream. As shown in the figures, the preferred shape for the electrodes is either a parabolic or a “modified U shape”. The shape is basically that of the letter “U”, with a bottom portion and more-or-less perpendicular side portions. However, the “modified-U” preferred shape has sides which are not perpendicular, but angled nearly to a “V” shape, and the sides meet the bottom at a radius, rather than a right angle, as shown.

The “modified U shaped” electrode assembly is a very efficient design and method for separating solids from an air stream. The major forces used to separate the particles from the air stream are the force of gravity that exerts a vertical downward force, the electrical inductive field force generated between the plate and grid electrodes and the angular, tangential force exerted on the particles as they traverse the angular section and around the radius of solid and grid electrodes.

The combination of the electrical field and the physical radius of the modified-U shaped electrode contribute to efficient separation by inducing turbulence and drag components to the air stream and particles.

The entrained air enters at (47) and is immediately subjected to the electrical lateral forces established between the modified U shaped plate electrode (48) and the wire grid electrodes (52) and (53). The entrained air (50) is drawn down the surface of the modified U shaped plate electrode (48) by the exhaust system located after the exit (1). As the air (50) flows down the angular section (56), the particulates (49) are laterally expelled (51) from the airflow. When the entrained air reaches the start of the radius (54) or tangent point, shown in FIG. 5, the particles have a natural tendency to continue in a straight path due to the mass of the particulates. Particles traveling along the radius (55) are subject to additional stresses due to the increase in the drag forces on both the air and particulates. These physical forces combined with the electrical repelling forces produce a very efficient method for removing particulates from a moving air stream. Some of the other factors that affect the separation are the density and conductivity of the material, air velocity, air volume and solids to gas ratio. The temperature of the U shaped plate electrode is preferably controlled. The inside surface (57) can be heated or cooled by electrical or other means.

FIG. 4 also shows conducting wires (58) at electrical ground level. The conducting wires (58) neutralize electrical charges that remain on some of the particles after passing through the last grid electrode. This is especially useful for processing fine particulates. Similar devices can be used in all of the designs herein. It is important to neutralize the charge on the particles, especially the fine particles that have been separated from the air stream.

In one embodiment, a grid type electrostatic separator/collector (GES/C) includes alternating discharge and grid type electrodes. Using parallel and opposing grid electrodes achieves early lateral transfer of particles through the grid into an area where the airflow is at a lower velocity or static conditions.

The centrally located discharge corona electrode shown in FIG. 2 uses standard wire or saw-tooth configurations. In contrast, in some embodiments of the present invention, a combination of alternating saw tooth or wire type discharge and grid type electrodes that have different circuits that operate at different levels of current and voltage are used. This series of electrodes is preferably centrally located between the parallel grid or plate electrodes.

When a discharge electrode is placed between parallel grid electrodes and a voltage is applied, an electric field is established, generating flux lines that charged particles follow, ions, and an electric wind that introduces predictable turbulence.

At the surface of the grids, the air velocity develops turbulence or a shear factor associated with the boundary layer, generating unstable eddy or vortex rotation. The combination of the above factors also improves the separation and traverse of particles from the main air stream and into the lower air velocity collection area.

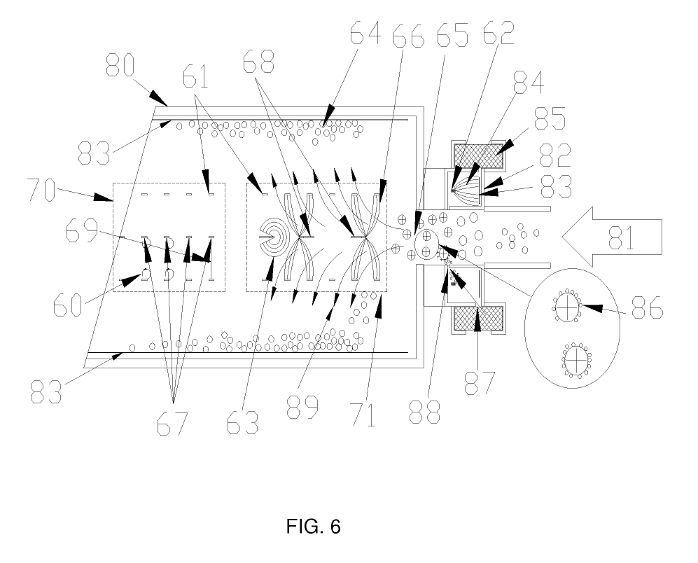

FIG. 6 shows a grid electrostatic separator/collector (80) of the present invention. Entrained air input (81) enters the collector (80) and usually includes both conductive and nonconductive particles. A pre-charger (82) includes a discharge electrode (62) and a plate electrode (83) plus a filter (85) that is used to prevent contaminating outside dust from coating the discharge (62) and plate electrodes (83). Air flows (87) through the pre-charger (82) and ions are released from the pre-charger (82) and are drawn through an aperture (88). The ions attach (86) to the non-conductive particles.

The particles then travel through the collector aperture (65) into the main part of the collector (80). The collector (80) includes a series of alternating central discharge electrodes (68) and central grid electrodes (67) centrally located between the parallel grid electrodes (61). Although three central discharge electrodes (68) and five central grid electrodes (67) are shown in FIG. 6, any combination using both discharge electrodes (68) and grid electrodes (67) as the central electrodes could be used in embodiments of a grid electrostatic precipitator/collector (80) of the present invention.

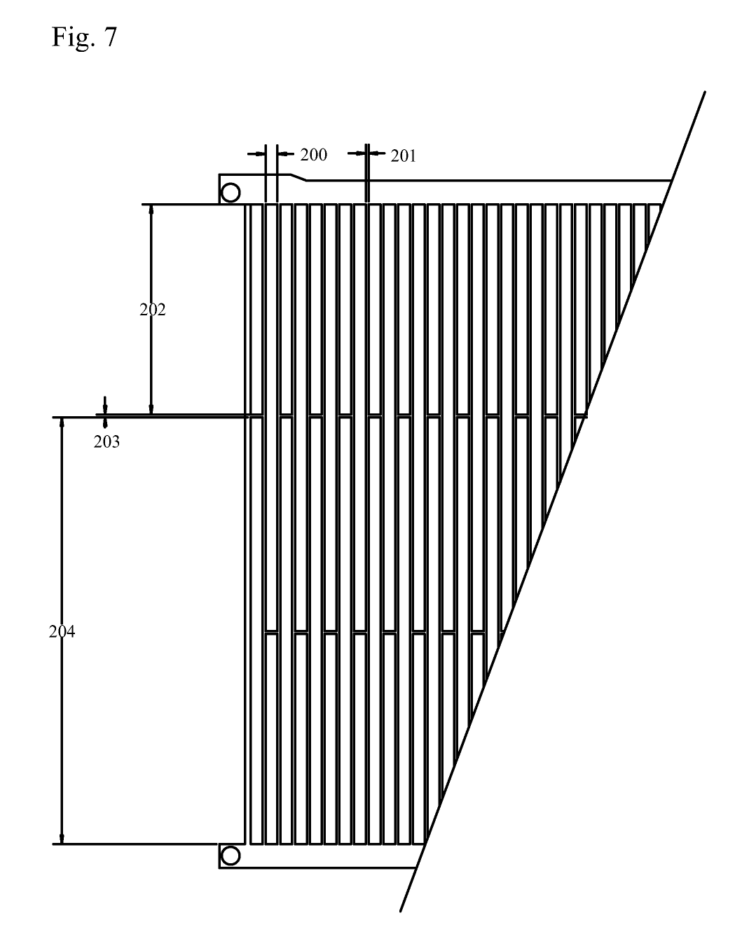

An example of a grid that may be used in the electrostatic precipitator/collector of the present invention is shown in FIG. 7. A small opening (202) of the grids alternates with a large opening (203) of the grids. An example of the dimensions that could be used include 0.250 inches for the opening width (200), 0.060 inches for the thickness (201), (203) of the web material, 4.421 inches for the small opening (202) of the grids, and 8.983 inches for the large opening (204) of the grids. These dimensions are examples only; the grid varies in size depending on the application.

The electric field (84), established when central discharge electrodes (68) are placed between parallel grid electrodes (61), generates flux lines (66). Charged particles laterally move (89) in a direction following the flux lines (66) and an electric wind (63) introduces predictable turbulence. At the surface of the grids (61) and (67), the air velocity develops turbulence or a shear factor associated with the boundary layer generating unstable eddy or vortex (60) rotation. Particles are collected (64) on the plate electrodes (83).

In a preferred embodiment, the spacing (69) between central grid electrodes (67) and the parallel opposing grid electrodes (61) varies between 0.50 and 1.50 inches. The same distance variation preferably applies to the distance between the central discharge electrodes (68) and the parallel opposing grid electrodes (61).

The series of discharge and grid type electrodes preferably have different circuits that operate at different levels of current and voltage. As an example, FIG. 6 shows two of those circuits (70) and (71).

The present invention replaces the corona discharge electrodes (21) of FIG. 2 with a series of a combination of central discharge electrodes (68) and central grid electrodes (67). The collector of the present invention combines the advantages of high voltage obtained from using a central grid electrode (67) and also the advantage of having corona-generating electrodes to better collect non-conductive particles.

Some advantages of the embodiments employing a series of alternating discharge electrodes and grid electrodes include improved charging of particulates, faster removal of entrained particles from the main air stream and onto the collecting plates, which results in shorter and less expensive equipment, and the ability to have improved field effects by having both a high voltage-high current for the discharge-grid conditions and a higher voltage-low current condition for grid-grid conditions, resulting in more efficient lateral particle removal and collection.

The combination of electrodes also achieves a stable corona discharge by controlling both the voltage and the current. Drift velocity is not a major concern because the distance the particles have to travel before they are out of the main air stream is short. The distance between the discharge and extracting or grid electrodes is relatively close, preferably 0.50 to 1.50 inches.

During the early process of charging particulates, blinding or interference from other particles can occur prohibiting all particles from reaching the maximum charge and responding to the flux lines of the electric field. By alternating single or multiple groups of discharge and grid electrodes along the length of the collection chamber, the problem is substantially reduced.

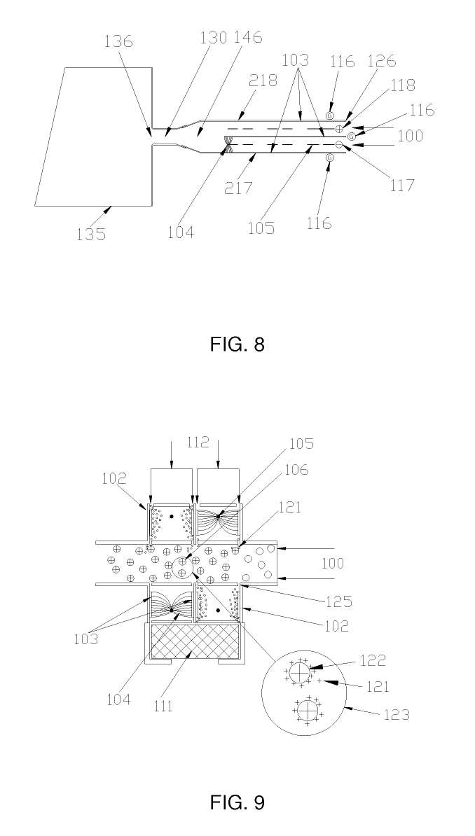

FIG. 8 is a cross sectional view of an external dual channel discharger (126) where the entrained air enters (100) and exits through the orifice (136) into the collection chamber (135). The collection chamber will be referred to as a “field” herein, similar to the term used by the electrostatic precipitator (ESP) industry. Particles are polarized in separate chambers (a negative chamber (217) and a positive chamber (218)) with a negative (117) and positive (118) discharge using a high voltage direct current (HVDC). The exterior sides and the center plate separating the two sides (103) are at ground potential (116). Charged particles exiting the polarizing channels (217) and (218) converge in a converging air zone (146) and mix to agglomerate (106) (see FIG. 9) into larger particles. Other components include the discharge electrodes (105) and the plate electrodes (103). An electric field (104) is established between these electrodes (103) and (105) perpendicular to the air flow. Ions generated by the discharge electrode (105) follow the flux lines of the electric field (104) and interact with the particles, resulting in charged particles. Charging of particulates is also improved because of the close distance between the discharge and plate electrode resulting in a high gas ion to particle ratio.

In this embodiment, the present invention has dual channels (217) and (218) where the particles are charged with opposite polarities using a high voltage direct current. The particles then flow into a converging air zone (146) where the polarized particles mix and agglomerate (106) into larger particles. The agglomeration (106) continues as the particles flow into a narrow single channel (130) before entering the collection chamber (135). In a preferred embodiment, the width of the single channel (130) ranges from ¾ inches to 2½ inches. Using narrow airflow channels (217) and (218) in the discharger improves the probability of agglomerating the fine particles by exposing the particles to a high concentration of polarized particles. In a preferred embodiment, the width of each of the airflow channels (217) and (218) are the same, and ranges from ¾ inches to ½ inches such that the total width of both channels ranges from ½ inches to 3 inches.

In an example of the dual channel discharger (126), the dimensions include ⅜ of an inch between the plate electrodes (103) and discharge electrodes (105) such that each of the polarizing channels (217) and (218) are ¾ inches wide. In this example, the single channel (130) is preferably 1 inch wide.

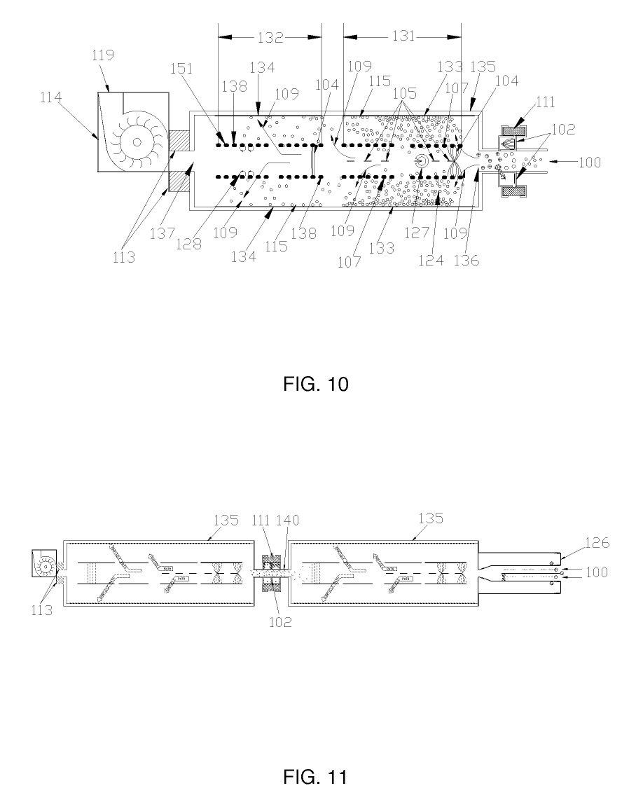

FIG. 9 shows a cross sectional view of opposing external enclosed discharge chambers. Although two opposing discharger chambers (102) located on each side of the input channel are shown in this figure, additional discharge chambers (102) are also within the spirit of the present invention. For example, a greater number of discharge chambers (102) may be required for higher velocities. Each chamber includes a corona discharge electrode (105), two plate electrodes (103), two chamber air input orifices (112), two filters (111) (shown in FIG. 10 and FIG. 11), one over each side of the input orifices (112), and two control exit orifices (125) where the generated ions (121) enter the main air stream. The close up view (123) illustrates the charging of a non-conductive particle (122) by ion (121) attachment.

In a preferred embodiment, the width of the main air stream, which is also the distance between the two chambers (102), is preferably in the range of ¾ to 2½ inches. In another preferred embodiment, the width of the output orifice (125) from the discharge chambers (102) into the main air stream preferably ranges from 10/1000 inch to 60/1000 inch.

Advantages of this system include the ability to adjust the ion input by varying either the orifice width (125) or the operating current. Another advantage is that the discharge electrodes are kept clean, resulting in maintaining a consistent ion input. Fine particle agglomeration is effective in this system because of the narrow air channel and the turbulent airflow created by the ions being drawn into the main air stream.

FIG. 10 is a cross sectional view of a collection chamber/field (135) showing a preferred electrode configuration for collection of sub-micron particles. Used in conjunction with a tangential blower (114) that exhausts at (119) are the input (136) and output (137) orifices that create a narrow air stream that flows past two independently controlled electrical zones (131) and (132). These zones include the discharge zone (131) that has a separate circuit including separate plate electrodes (133), grid electrodes (107) and the discharge electrodes (105). In this zone (131), the current is the controlling factor. The second zone (132) has separate plate electrodes (134) and opposing and parallel grids (138), where a higher voltage can be applied. The plate electrodes (133) in the first zone (131) can operate separately from the plate electrodes (134) in the second zone (132). The second zone (132) has a much higher field strength, which allows it to collect the sub-micron particles. The second zone (132) preferably does not have discharge electrodes (105).

The discharge zone (131) is placed first because agglomerated particles will lose most of their charge and need to be recharged in order to continue to agglomerate. Particles that are not collected in zone (131) will be subjected to a higher voltage in zone (132), resulting in a stronger electrical field (104) that improves collection of sub-micron particles.

The collection process begins with particles entering at orifice (136) and being polarized by the corona from the discharge electrodes (105). The charged particles then respond to the opposite polarity of the grid electrode (107) and the electric field (104) and move laterally (109) or perpendicular to the airflow by following the flux lines of the electric field. Because of the momentum of the particles, the particles pass through the grid (107) into an area where there is a sharp drop in the air velocity (151) and decreases to near static conditions (115) at the collection plate surface (133) and (134). The sharp drop in flow immediately behind the grid electrode (151) is dependent on the porosity of the grid and airflow operating parameters. Due to the close proximity of the electrodes in the first zone (131), charging of the particles is aided by the turbulence created by the corona wind (127), movement of ions and the eddy currents (128) generated at the surface of the grid electrodes (107) and (138).

Sub-micron particles are collected when charged particles (124) follow the flux lines of the electrical field (104) and move laterally (109) through the grid electrode (107) into an area where there is a sharp drop in air movement and reaching near static conditions at the collecting plate surface (115).

In one example, the typical dimensions for one field include a distance between the discharge electrodes (105) and grid electrodes (107) that is preferably between ½ inches and 1.0 inch. The width of the collection chamber (135) is preferably 6.0 to 12.0 inches. The width of the grid electrodes can vary between 6 and 12 inches, depending on the structural size of equipment. There are preferably 3 to 6 discharge electrodes (105) per grid and 3 to 4 grid electrodes (107), (138). The length of the combined processing zones (131) and (132) is preferably 18 to 24 inches. The input (136) and exit (137) orifices are preferably each 1.0 to 2.0 inches wide.

The length of the processing zones, the number of electrodes, and the height will vary depending on the application. Another dimension that will vary based on the size and operating requirements is the aspect ratio of the width of the input and output orifice to the width of the field or collecting chamber. In preferred embodiments, aspect ratios of 10:1 or 3:1 may be used.

The external enclosed discharger shown in FIG. 9 is different than the one shown in FIG. 10 in that there is only one exit orifice (137) and one plate electrode (103) in FIG. 10, while in FIG. 9, there are two plate electrodes (103) one on both sides of the discharge electrode (105) and two exit orifices (125). Filters (111) shown over the input orifices (112) in FIG. 10 would normally be used with the design shown in FIG. 9. The filters maintain consistent long-term operation by keeping the electrodes clean.

Another method for improving the collection of fine and sub-micron particles is to recharge the particles more frequently. It is difficult to charge, agglomerate and collect ultra fine particles. The collection by the first field may be high but it is not 100 percent. Some of the particles will not be sufficiently charged to respond to the electrical field. By re-charging and then re-agglomerating these particles at frequent intervals, the process becomes more efficient.

FIG. 11 illustrates the concept of using two or more fields (135) in series along with external dischargers (126) and (102). The two chambers are preferably fairly close together. In a preferred embodiment, the apparatus has a short 1 to 2 inch straight section (140) for air flow control and then the discharge section (126) or (102). Details of preferred embodiments of the fields are shown in FIG. 10, while FIGS. 8 and 9 give details of the external discharger (126) and (102). Although the electrode configuration from FIG. 10 is shown in FIG. 11, other electrode configurations disclosed herein, as well as electrode configurations known in the art, or combinations of different electrode configurations could be used for the collection chambers in this embodiment.

Although two chambers are shown in FIG. 11, additional chambers are also within the spirit of the invention. In fact, more fields (135) in series may further increase the chances of collecting the sub-micron particles. There is preferably at least one discharge (102) or (126) between each of the collection chambers (135). Having multiple fields (135) and/or discharge chambers increases the success rate in collecting the sub-micron particles.

Collecting sub-micron particles is also tied into continuously collecting both inorganic and organic particles. The particles may be recharged by an energy source (113). One method for recharging the particles uses an ultraviolet energy source. FIG. 10 and FIG. 11 indicate the position of an ultra violet energy source (113). Alternative energy sources for recharging the particles include plasma energy or microwave energy. Any of these energy sources could be used after the first field to charge and/or destroy the organic particles.

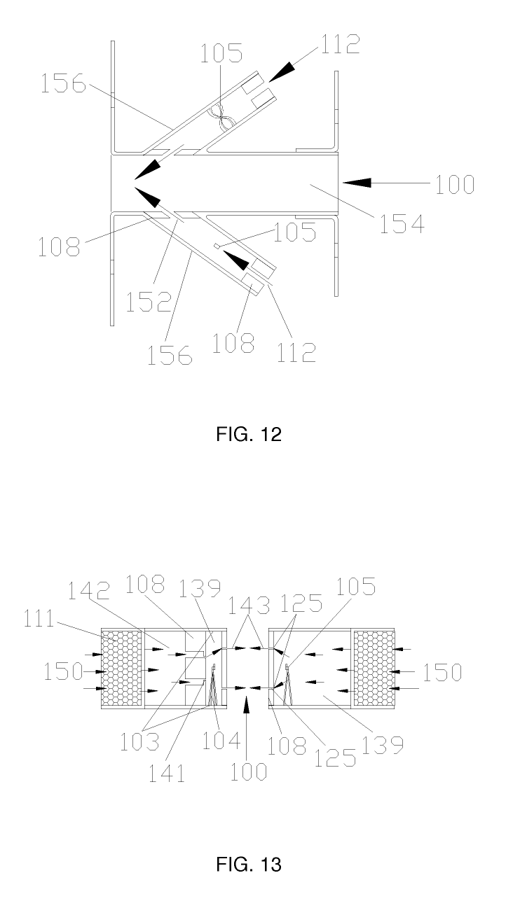

The pre-charger shown in FIG. 12 draws air to be charged through orifices (112) and (152) into the main entrained air stream (100) at a 45-degree angle. The 45-degree angle reduces the chance of air turbulence or eddies causing particles to accumulate at the exit of the orifice and blocking the orifice. Controlling the amount of air flowing through the orifice reduces this problem. Other controlling factors are the width of the narrow pre-charger chamber (156), location of the discharge electrode (105) and the thickness of the dielectric material (108). The input orifices (112) and output orifices (152) permit controlled amounts of air to be drawn into the chamber to be electrically charged and mix in a narrow channel (154) with the main entrained air flow (100). In one embodiment of a grid electrostatic precipitator, the design of the corona-generating electrode uses the 45-degree angle chamber shown in FIG. 12.

In other embodiments, other pre-charger designs may be used. One of the arrangements, shown in FIG. 13, shows a cross-sectional view of two saw tooth corona electrodes (105) in an elongated corona chamber (139) attached together and facing in the opposite direction. The tips of the saw tooth corona electrode (105) face the grounded attracting plate electrodes (103) and operate with an electrical field (104) between the two electrodes (105) and (103).

On the left hand side of FIG. 13, the gases (150) to be charged are filtered and enter through a control orifice (141) close to the charging electrodes, pass through a HVDC electric field (104) and exit through another controlling orifice or aperture (125) near the attracting plate electrode (103). The spacing between the corona electrode (105) and the dielectric material (108) are preferably in the low 1 or 2 thousandths to 10 or more depending on the flow conditions of the main air stream (100) and the need to have enough flow and velocity of air and ions to keep the corona electrodes (105) clean. The chamber behind the first input orifice (141) acts as a plenum chamber (142) that provides a uniform distribution of air to the corona-charging electrode (105). Ions (143) are preferably injected perpendicular and into the entrained air stream.

The right hand side shows a slight modification where the input gases (150) are drawn through the air filter (111), but do not pass through controlling apertures (141). The input gases (150) only exit through the controlling apertures (125) near the attracting plate electrode (103). Selection of the location of the input orifice and the exit orifice is important because it permits the generated ions entering the main entrained air stream to exit the chamber before losing their charge to the attracting electrode. Other design and operating features of this apparatus include the ability to increase the distance between the corona (105) and attracting plate electrodes (103) so that a higher voltage is generated and maintained, resulting in the production of more ions.

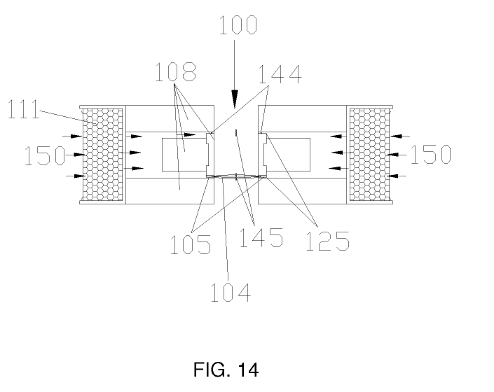

FIG. 14 shows another apparatus that improves ion generation and still protects the charging electrode. This design improves the penetration of the generated ions into the center of the main air stream (100) while still protecting the charging electrode. The corona electrodes (105) are located in the slotted apertures or orifices (125) made of dielectric material (108) that is not affected by the corona discharge and where the gases to be charged (150) flow close to or over the surface of the corona electrodes (144) and (105) and become ionized and are attracted to the plate or ribbon electrodes (145) that are centrally located between the corona electrodes, by the HVDC electric field. The ribbon attracting electrodes (145) are centrally located between the opposing corona electrodes and in the retained airflow.

The corona electrodes generate controlled amounts of electrically charged gases that are attracted to the opposing attracting electrode by the electrical field (104). These charged particles are preferably drawn into the main stream (100) by negative pressure of the precipitator, or forced into and mixed under low pressure with the main entrained airflow (100). Having the ability to protect the corona-generating electrode opens the door to extending the life of electrodes and generating higher ion counts using less energy.

In a preferred embodiment, the width of the main air stream (100) ranges from ¾ to 2½ inches. In one example, the width is 1 inch.

The high velocity gases and particulates in the main air stream (100) keep the attracting electrodes (145) clean. The charging corona electrodes (144) and (105) are kept clean by the positive constant flow of gases over the surface of the electrodes. Clearance between the electrode and sidewall of the orifice may vary and is based on operating parameters of the GEP. If the pre-charger design of FIG. 14 was used with the precipitators shown in FIGS. 10 and 11, it would require a slightly wider input channel to compensate for the width of center ribbon electrodes (145).

It should be noted that, in the case of designs shown in FIGS. 13 and 14, the number of corona electrode units, inline with the airflow, are examples only. The number may vary, depending upon the application and process requirements.

The pre-charger arrangements shown in FIG. 13 and FIG. 14 could be used instead of the pre-chargers of FIGS. 8 and 9 in combination with any of the precipitators disclosed herein, including, but not limited to, the precipitators shown in FIGS. 10 and 11 and the precipitator embodiments including alternative grid and discharge electrodes.

Accordingly, it is to be understood that the embodiments of the invention herein described are merely illustrative of the application of the principles of the invention. The embodiments can also be used in combination with each other, within the spirit of the present invention. Reference herein to details of the illustrated embodiments is not intended to limit the scope of the claims, which themselves recite those features regarded as essential to the invention.

What is claimed is:

1. A method of collecting a plurality of particles, comprising the steps of:
a) passing particles through a pre-charger to generate ions;
b) drawing the ions into an air stream such that the ions become attached to the particles;
c) agglomerating the particles; and
d) recharging the particles.

2. The method of claim 1, further comprising the step of repeating steps a) through d).

3. The method of claim 1, wherein at least one of the particles is a sub-micron particle.

4. The method of claim 1, further comprising the steps of:
e) passing the air stream between a plurality of grid electrodes, each grid electrode having an opposite polarity as the grid electrodes adjacent to it such that an attractive field is created and the attractive field causes the particles pass through at least one grid electrode into a static air movement zone where particles are collected.

5. The method of claim 4, further comprising the steps of attracting the particles which have passed through a grid electrode to the next attracting grid electrode until the particles are out of the air stream in the static air movement zone and collecting the particles in a collection chamber.

6. The method of claim 4, further comprising the step of drawing the air stream into an apparatus comprising the grid electrodes and the static air movement zone.

7. The method of claim 4, further comprising the step of utilizing a negative air pressure during steps a) through e).

8. The method of claim 1, wherein the air stream is selected from the group consisting of a single column of air flowing in a vertical direction and a single row of air flowing in a horizontal direction.

9. An apparatus for removing particles from an air stream, comprising:
a) an input aperture for the air stream entering the apparatus;
b) an output aperture located on an opposite side of the apparatus from the input aperture, wherein the air stream exits the apparatus at the output aperture;
c) a plurality of grid electrodes located between the input aperture and the output aperture such that when opposite charges are applied to adjacent grid electrodes, an attractive field is created and the particles in the air stream pass through at least one grid electrode into the static air movement zone where the particles are collected; and
d) a recharger that recharges the plurality of particles.

10. The apparatus of claim 9, wherein the recharger comprises a corona discharger located outside the air stream, wherein the corona discharger generates a plurality of ions and wherein the ions are drawn into the air stream such that the ions become attached to a plurality of particles.

11. The apparatus of claim 9, wherein the recharger comprises an ultraviolet energy source.

12. An apparatus for charging particulates that need to be removed from an entrained air stream, comprising:
a) at least one collection chamber; and
b) an enclosed dual channel pre-charger located external to the collection chamber and outside of the air stream, wherein the pre-charger comprises a positive polarizing channel that generates positive ions and a negative polarizing channel that generates negative ions, wherein generated ions are drawn into the entrained air stream such that the ions become attached to a plurality of particles in the apparatus.

13. The apparatus of claim 12, wherein the collection chamber comprises:
i) an input aperture for the air stream entering the collection chamber;
ii) an output aperture located on an opposite side of the collection chamber from the input aperture, wherein the air stream exits the apparatus at the output aperture;
iii) a plurality of grid electrodes located between the input aperture and the output aperture; and
iv) a static air movement zone;
such that when opposite charges are applied to adjacent grid electrodes, an attractive field is created and the particles in the air stream pass through at least one grid electrode into the static air movement zone where the particles are collected.

14. An apparatus for charging particulates that need to be removed from an entrained air stream, comprising:
a) at least one collection chamber; and
b) an external opposing enclosed discharger located outside of the air stream, wherein the discharger generates a plurality of ions and wherein the ions are drawn into the entrained air stream such that the ions become attached to a plurality of particles in the collection chamber, comprising:
i) a single input channel where entrained particles in the air stream are drawn though the discharger;
ii) at least one first discharger chamber located on a first side of the input channel, comprising at least one corona discharge electrode, at least one plate electrode, at least one air input orifice, and at least one output orifice, wherein a plurality of ions exit the discharger chamber through the output orifice; and
iii) at least one second discharger chamber located on a second side of the input channel opposite the first side, comprising at least one corona discharge electrode, at least one plate electrode, at least one air input orifice, and at least one output orifice, wherein a plurality of ions exit the discharger chambers through the output orifice.

15. The apparatus of claim 14, wherein the collection chamber comprises:
i) an input aperture for the air stream entering the collection chamber;
ii) an output aperture located on an opposite side of the collection chamber from the input aperture, wherein the air stream exits the apparatus at the output aperture;
iii) a plurality of grid electrodes located between the input aperture and the output aperture; and
iv) a static air movement zone;
such that when opposite charges are applied to adjacent grid electrodes, an attractive field is created and the particles in the air stream pass through at least one grid electrode into the static air movement zone where the particles are collected.

16. The apparatus of claim 14, wherein both of the discharger chambers further comprises at least one air filter.

17. An apparatus for removing particles from a single air stream, comprising:
a) an input aperture for the air stream entering the apparatus;
b) an output aperture located on an opposite side of the apparatus from the input aperture, wherein the air stream exits the apparatus at the output aperture; and
c) a plurality of first electrodes;
d) a plurality of second discharge electrodes centrally located between the first electrodes;
d) a plurality of third grid type electrodes with a separate electrical circuit from the second discharge electrodes and centrally located between the first electrodes;
such that when opposite charges are applied to adjacent grid electrodes and discharge electrodes, an attractive field is created and the particles in the air stream pass through at least one grid electrode or discharge electrode into a static air movement zone where the particles are collected.

18. The apparatus of claim 17, wherein the first electrodes are selected from the group consisting of a plurality of parallel grid electrodes and at least two plate electrodes.

19. The apparatus of claim 17, further comprising a pre-charger located outside the single air stream, wherein the pre-charger generates a plurality of ions that are drawn into the single air stream such that the ions become attached to a plurality of particles.

20. A method of improving the rate of lateral movement and collection of particles, comprising the steps of:
a) passing an air stream between an inline series of alternating discharge electrodes and grid type electrodes each with a separate electrical circuit centrally located between either parallel grid electrodes or plate electrodes.

21. The method of claim 20, further comprising, before step a), the steps of:
b) passing particles through a pre-charger to generate ions; and
c) drawing the ions into the air stream such that the ions become attached to the particles.

22. A grid type electrostatic separator/collector comprising at least one collection chamber comprising at least two separate electrode arrangements within the collecting chamber.

23. The grid type electrostatic separator/collector of claim 22, wherein each collection chamber comprises a first electrode arrangement and a second electrode arrangement;
wherein the first electrode arrangement comprises a discharge zone where current is a controlling factor, comprising at least two plate electrodes, a plurality of grid electrodes located between the plate electrodes, and a plurality of discharge electrodes centrally located between the grid electrodes and the plate electrodes; and
wherein the second electrode arrangement comprises a voltage zone where voltage is a controlling factor, comprising a plurality of plate electrodes and a plurality of opposing and parallel grid electrodes located between the plate electrodes.

24. The grid type electrostatic separator/collector of claim 23, wherein the discharge electrodes in the discharge zone recharge the particles.

25. The grid type electrostatic separator/collector of claim 23, wherein the plate electrodes in the voltage zone collect a plurality of particles including at least one sub-micron particle.

26. The grid type electrostatic separator/collector of claim 23, comprising at least two collection chambers placed in series.

27. The grid type electrostatic separator/collector of claim 26, further comprising at least one charging chamber placed in a location selected from the group consisting of:
a) before a first collection chamber in the series;
b) between two collection chambers in the series; and
c) any combination of a) and b).

28. A grid type electrostatic separator/collector comprising at least two collection chambers placed in series.

29. The grid type electrostatic separator/collector of claim 28, further comprising at least one pre-charging chamber placed in a location selected from the group consisting of:
a) before a first collection chamber in the series;
b) between two collection chambers in the series; and
c) any combination of a) and b).

30. A method for increasing ion penetration into a main air stream using an external pre-charger comprising a partially enclosed discharge electrode and a grounded electrode that is centrally located in the main air stream and located directly in front of the discharge electrode, comprising the steps of:
a) passing air through the partially enclosed discharge electrode;
c) developing an electric field between the partially enclosed discharge electrode and the grounded electrode;
c) drawing ionized air into the main air stream by a negative air flow from a collection chamber; and
d) attracting ionized air into the main air stream by following flux lines of the electric field established between the partially enclosed discharge electrode and the grounded electrode.

31. An apparatus for increasing ion penetration into the main air stream, comprising:
a) an external pre-charger comprising a partially enclosed discharge electrode and a grounded electrode that is centrally located in the main air stream and located directly in front of the discharge electrode, wherein an electric field is developed between the partially enclosed discharge electrode and the grounded electrode such that ionized air is attracted into the main air stream by following flux lines of the electric field established between the partially enclosed discharge electrode and the grounded electrode; and
b) a collection chamber comprising an input orifice, wherein the main air stream enters the collection chamber through the input orifice.
